(19) United States
(12) Patent Application Publication
(10) Pub. No.: US 2008/0088423 A1
(43) Pub. Date: Apr. 17, 2008

(54) CONTROL AND DISPLAY FOR WIRELESS SIGNAL LIGHT

(76) Inventor: Yung-Lung Liu, Ta Ya Shiang (TW)

Correspondence Address: G. LINK CO., LTD., 3550 BELL ROAD, MINOOKA, IL, 60447, US

(21) Appl. No.: 11/548,597

(22) Filed: Oct. 11, 2006

(51) Int. Cl. B62J 6/00; G09F 9/33

(52) U.S. Cl. 340/432; 340/815.45

(57) ABSTRACT

A control with display for RF wireless signal light includes a wireless remote control device and a sound-light warning device. The wireless remote control device further includes a light signal controller, a light signal switch circuit, a RF wireless signal emitter and a first battery set. The sound-light warning device further includes a RF wireless signal receiver, a light signal control circuit, a LED display, a buzzer and a second battery set. The RF wireless signal receiver receives the remote control signal from the RF wireless signal emitter. The remote control signal is treated as a turn signal or flash warning signal to be shown on the LED display and allow the buzzer producing warning sound with light.

### BACKGROUND OF THE INVENTION

1. Field of the Invention

The present invention is related to RF wireless signal light and particularly to a control and a display with which signal is remote-controlled wirelessly such that a turn signal or hazard flash signal for a bike can be displayed or warning sound and light can be emitted.

2. Brief Description of the Related Art

In order to take exercise and conserve energy source, riding a bike becomes one of popular sport tools loved by people. The conventional bike usually is equipped with insufficient safety device. It is known that a car and a motorcycle generally fully equip with turn signal lights and horns to warn others for safety. But, there are no turn signal lights provided with the bike so that it is dangerous to ride a bike in a dark area or on a raining day with bad vision condition though the conventional bike has provided with light reflection pieces and a bell stirring device. The reflection pieces only work with a strong light projecting light source so that they don't work well in case of weak head light or no light coming from the back of the bike. As for the bell stirring device, the stir stem and knocking rod in the bell stirring device are mechanical structure so that it is heavy and easy to become rusty and, sometimes, it is hard to be operated smoothly. Furthermore, the bell stir device merely produces pure knocking sound without emitting warning light.

### SUMMARY OF THE INVENTION

An object of the present invention is to provide a control and a display for RF wireless signal light, with which a turn signal or flash warning signal for a bike can be displayed or a warning sound and light can be emitted to enhance bike riding fun and safety for the rider.

In order to achieve the preceding object , a control and a display for RF wireless signal light includes a wireless remote control device and a sound-light warning device. The wireless remote control device further includes a light signal controller, a light signal switch circuit, a RF wireless signal emitter and a first battery set. The light signal controller sends a signal, which is a left turn signal, a right turn signal or a flash warning signal, to the light signal switch circuit via a touch key for being converted as a remote control signal; the RF wireless signal emitter sends out the remote control signal; and the first battery set supplies power required for operating the wireless remote control device. The sound-light warning device further includes a RF wireless signal receiver, a light signal control circuit, a LED display, a buzzer and a second battery set. The RF wireless signal receiver receives the remote control signal; the light signal control circuit treats the remote control signal as the left turn signal, the right turn signal or the flash warning signal; the LED display shows the turn signals or the flash warning signal, the buzzer produces warning sound with light; and the second battery set supplies power required for operating the sound-light warning device.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view illustrating a preferred embodiment of control and display for RF wireless signal light according to the present invention;

FIG. 2 is a block diagram illustrating signal transmission employed with control and display for RF wireless signal light according to the present invention;

FIG. 3 is a perspective view illustrating the control and display for RF wireless signal light shown in FIG. 1 being mounted to a bicycle; and

FIG. 4 is a perspective view illustrating the control and display for RF wireless signal light shown in FIG. 1 being associated with a person carrying a backpack.

### DETAILED DESCRIPTION OF THE INVENTION

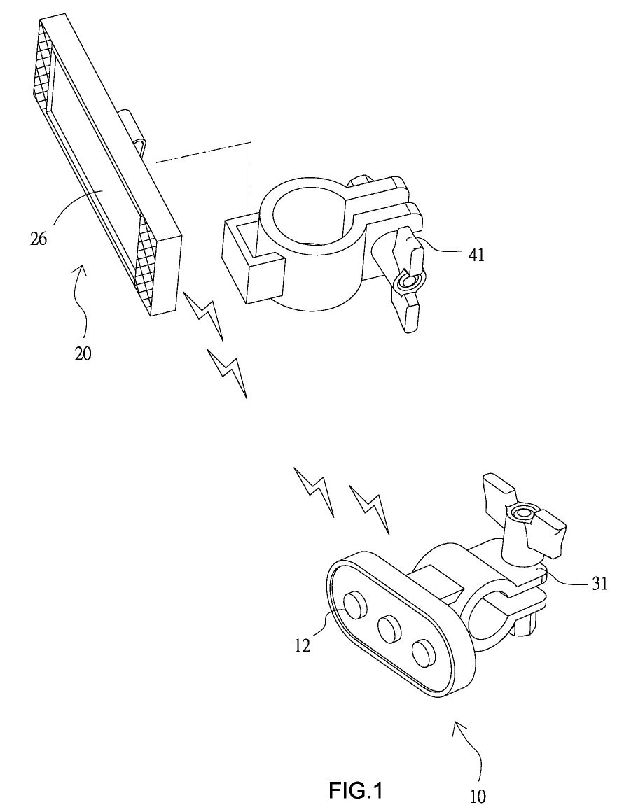

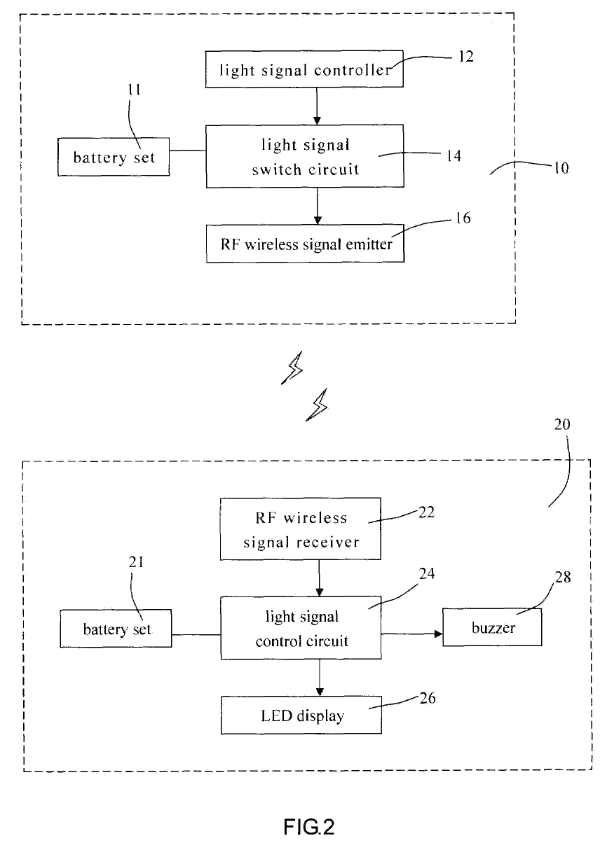

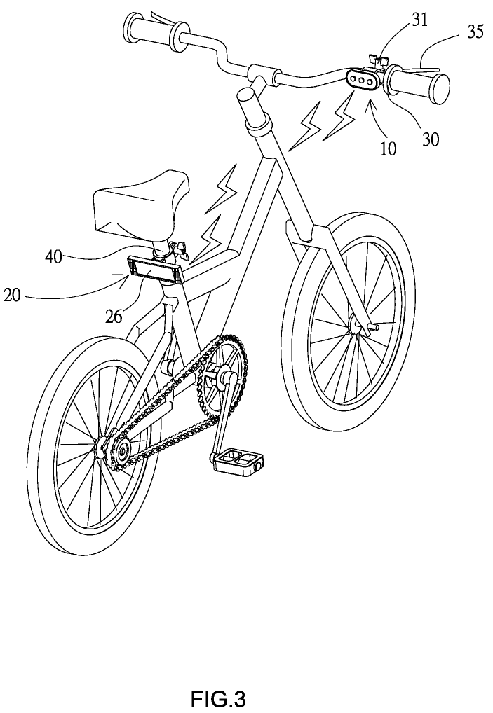

Referring to FIGS. 1 to 3, a control and display for RF wireless signal light according to the present invention, which specifically is a wireless remote control device mounted to a bicycle for displaying a turn signal or flash warning signal and emitting warning sound with light, includes a wireless remote control device 10 and a sound-light warning device 20. The wireless remote control device 10 provides a fastening member 31 for being capable of being attached to the handle bar of the bicycle next to the handle grip 30. The sound-light warning device 20 has another fastening member 41 for being attached to the upright pipe 40 under the seat pad and facing backward. In this way, the rider of the bike can operate the wireless remote control device 10 to remote-control the signal light on the sound-light warning device 20 to show a left turn signal, right turn signal or flash warning signal for enhancing bike riding fun and safety effect substantially.

Wherein, the wireless remote control device 10 further includes a light signal controller 12, a light signal switch circuit 14, a RF wireless signal emitter 16 and a battery set 11. The light signal controller 12 has touch keys for being operated and sends a signal such as a right turn signal, a left turn signal or a flash warning signal to the light signal switch circuit 14. The signal is executed and treated by the light signal switch circuit 14 as a control signal and the control signal is sent to the sound-light warning device 20 at the back of the bike via the RF wireless signal emitter 16 to perform wireless signal transmission. The battery set 11 supplies power required by the wireless remote control device 10. Further, the brake grip 35 can be provided with a touch switch (not shown) for sending a hand braking signal to the light signal controller 12 in the wireless remote control device 10 such that the hand braking signal can be transmitted wirelessly to promote safety of bike driving.

The sound-light warning device 20 further includes a RF wireless signal receiver 22, a light signal control circuit 24, a LED display 26, a buzzer 28 and a battery set 21. The RF wireless signal receiver 22 is provided to correspond to the RF wireless signal emitter 16 such that the control signal sent by the wireless signal emitter 16 is received by the RF wireless signal receiver 22 and treated by the light signal control circuit 24 before the LED display 26 is capable of showing the turn signal or the flash warning signal and/or before the buzzer 28 is capable of producing warning sound signal with light instead of the conventional bell stir device. Hence, both of display of signal and emission of warning sound with light can be performed with the present invention to enhance bike riding fun and safety for the rider tremendously. The battery set 21 supplies power required by the sound-light warning device 20. In addition, the sound-light warning device 20 is joined to the fastening member 41 and the fastening member 41 is attached to the upright pipe 40 next to the seat pad such that the sound-light warning device 20 faces backward for noting coming cars from the back of the bike.

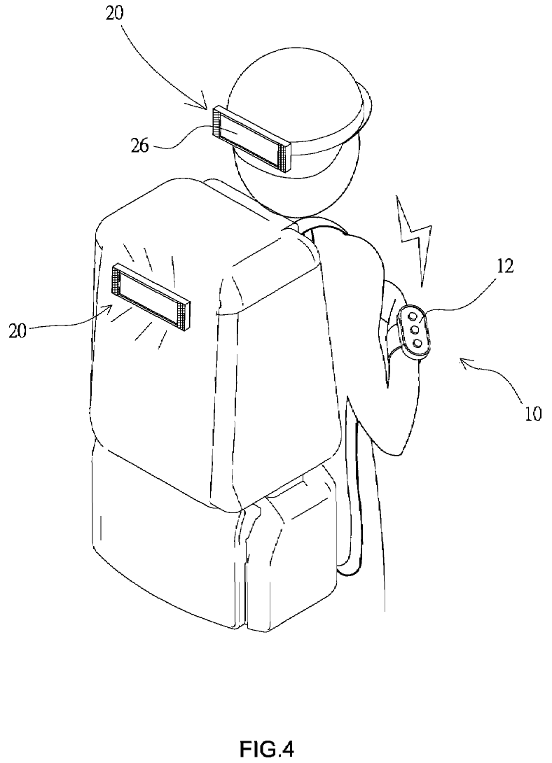

Referring to FIG. 4, the control and display for RF wireless signal light of the present invention can be applied with other movable equipment such as a backpack carried by a pedestrian and a safety helmet worn by the pedestrian shown in FIG. 4. It can be seen in FIG. 4 that the sound-light warning device 20 is attached to the backpack or the safety helmet and the wireless remote control device 10 is held at a wrist of the pedestrian for indicating moving direction of a group of people behind.

It is appreciated that the control and display for RF wireless signal light of the present invention has the advantage of remote-controlling directional signal lights with sound and light. Besides, the control of the present invention is wireless so that it is easy to be set up and operated in addition to having good looking appearance. Moreover, it is capable of being attached to the bike, the backpack, the safety helmet and the human body and the hand brake grip can be added with touch switch to supply brake signal being sent to the display and the buzzer for tremendously promoting bike driving safety.

While the invention has been described with referencing to preferred embodiments thereof, it is to be understood that modifications or variations may be easily made without departing from the spirit of this invention, which is defined by the appended claims.

What is claimed is:

1. A control with display for RF wireless signal light, comprising:
a wireless remote control device, further comprising a light signal controller, a light signal switch circuit, a RF wireless signal emitter and a first battery set, wherein the light signal controller sends a signal, which is a left turn signal, a right turn signal or a flash warning signal, to the light signal switch circuit via a touch key to be converted as a remote control signal; the RF wireless signal emitter sends out the remote control signal; and the first battery set supplies power required for operating the wireless remote control device; and
a sound-light warning device, further comprising a RF wireless signal receiver, a light signal control circuit, a LED display, a buzzer and a second battery set, wherein the RF wireless signal receiver receives the remote control signal; the light signal control circuit treats the remote control signal as the left turn signal, the right turn signal or the flash warning signal; and the LED display shows the left turn signal, the right turn signal or the flash warning signal, the buzzer produces warning sound; and the second battery set supplies power required for operating the sound-light warning device.

2. The control with display for RF wireless signal light as defined in claim 1, wherein the wireless remote control device provides a first fastening member to be attached to a handle bar of a bike next to a handle grip of the bike and the sound-light warning device provides a second fastening member to be attached to a upright pipe of the bike next to a seat pad of the bike.

3. The control with display for RF wireless signal light as defined in claim 2, wherein a brake handle of the bike provides a touch switch to send a braking signal to the light signal controller for the braking signal being capable of being transmitted.

4. The control with display for RF wireless signal light as defined in claim 1, wherein the sound-light warning device is attached to a backpack carried by a pedestrian and the wireless remote control device is held at a wrist of the pedestrian.
